(19) United States
(12) Patent Application Publication
(10) Pub. No.: US 2026/0326230 A1
(43) Pub. Date: Oct. 22, 2026

(54) METHOD FOR PRODUCING A COMBINATION OF EXPANDED METAL MESHES, STACK OF EXPANDED METAL MESHES, AND PORTAL MACHINE

(71) Applicant: Siemens Energy Global GmbH & Co. KG, München (DE)

(72) Inventors: Alexander Spies, Kemnath (DE); Simon Kiesslich, Erlangen (DE); Philip Terhorst, Essen (DE); Tim Schreiber, Witten (DE); Julian Sper, Dinslaken (DE)

(21) Appl. No.: 19/109,693

(22) PCT Filed: Aug. 24, 2023
(86) PCT No.: PCT/EP2023/073272

§ 371 Date: Mar. 7, 2025

(30) Foreign Application Priority Data
Sep. 7, 2022 (DE) 10 2022 209 312.7

(51) Int. Cl. B23K 13/00

(52) U.S. Cl. CPC B23K 13/00

(57) ABSTRACT

A method for metallurgically bonding multiple metallic layers over a large surface, includes using a capacitor discharge welding process in which several capacitors are discharged one after the other. At least two pulses are used, the at least two pulses differing by at least 10% at least in terms of energy density in J/mm². A stack of expanded metal meshes welded together and a portal machine for a capacitor discharge welding method, are also provided.

The invention relates to a method for producing a combination of expanded metal meshes, which are used, in particular, for electrolysis, a stack of expanded metal meshes, and a portal machine.

Fine pored and graduated structures are required for a PEM electrolysis cell for flat contacting of the electrodes.

This is done with sintered structures which are complicated to produce and thus very expensive (also see EP 3 625 379 A1).

Newer developments are built on alternative graduated structures such as expanded metal mesh layers bonded to one another. Such expanded metal mesh layers are known, among others, from EA 010551 B1, EP 0 204 126 A1 or EP 3 625 379 A1.

The bond is via a so-called CD welding process (capacitor discharge) under protective gas. Such a method and such a plant is known from EP 1 852 207 A2.

For this purpose, a so-called capacitor discharge welding process is used which is created through the discharge of a capacitor. Thus, a welding pulse is sent. If one desires to weld with more energy, the charging height of this pulse must be heavily increased.

However, one problem, in particular when processing stainless steel, is the formation of so-called welding splashes through the sudden heating of the atmosphere around the welding spot and the resulting output of liquid metal.

Also, through the standard use of a so-called C arc machine, the size of the welding stamp (welding electrodes) is limited, which requires many welds in the x and y direction over large surfaces and promotes splash formation through the introduction of a one-sided magnetic field.

Furthermore, the flatness of the expanded metal mesh combination is relevant to quality for the PEM electrolysis cell.

It is therefore an object of the invention to solve the above-mentioned problems.

The object is achieved through a method according to claim 1, a stack according to claim 17 and a portal machine according to claim 18.

The dependent claims list further advantageous measures which can be combined as desired in order to achieve further advantages:

Wherein:

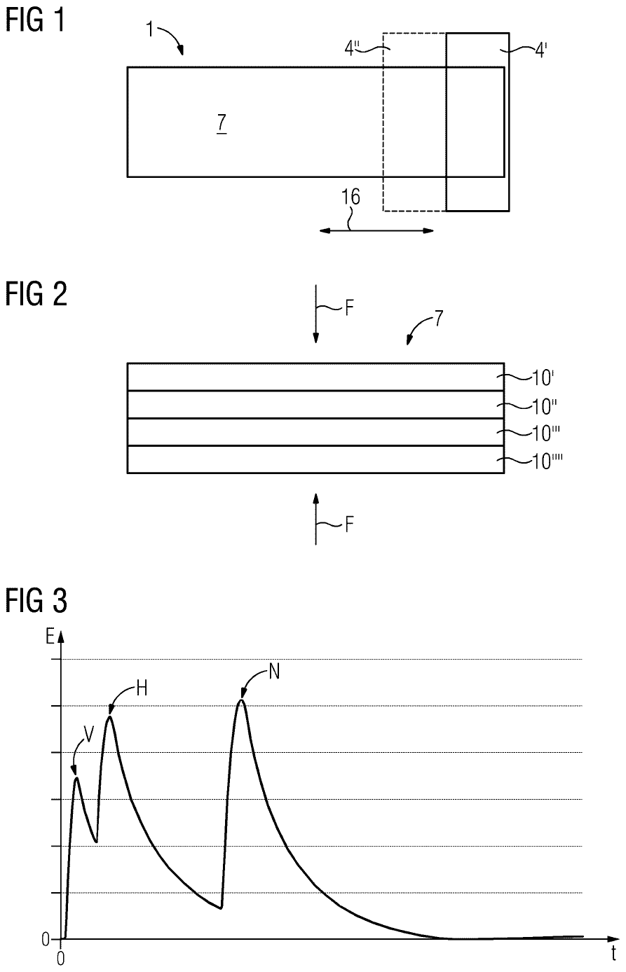

FIG. 1 schematically shows a top view of an arrangement during welding,

FIG. 2 shows an arrangement of expanded metal meshes,

FIG. 3 shows an example temporal course of used pulses,

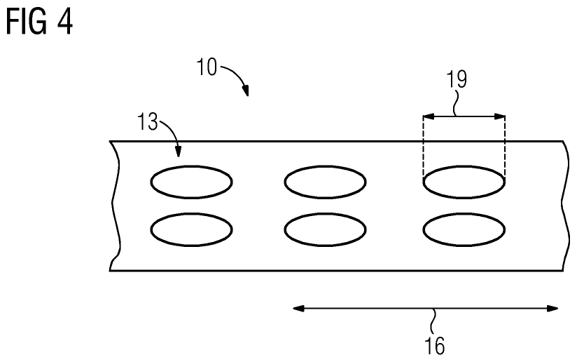

FIG. 4 shows a detailed view of an expanded metal mesh.

The figures and the description only represent example embodiments of the invention.

A new welding machine type, a portal welding machine which also includes several capacities/capacitors connected in parallel, which can be controlled successively in a time-controlled manner, substantially improves the CD welding process.

Through this CD welding process, both stainless steel and titanium structures can be bonded.

If a longer welding pulse is required, the energy of a capacitor does not necessarily have to be significantly increased, which leads to a more uniform heat introduction into the welding zone and decreases the undesired welding influence zones.

The welding stamp size is significantly increased, which requires significantly less welds per combination.

Also, this enables a throughput process, which can also be continuous.

FIG. 1 schematically shows an arrangement 1 with a top view of a stack 7 (or combination) of at least two or more expanded metal meshes 10, 10′, 10″, . . . (FIG. 2) and electrodes 4.

The expanded metal meshes 10, 10′, 10″, . . . have a preferably rectangular shape and an aspect ratio of at least 1.2, in particular at least larger than 2.0.

Such a stack 7 of expanded metal meshes 10, 10′, 10″, . . . is introduced into the portal welding machine and welded together there by means of stamps which represent the electrodes 4.

The electrodes 4 preferably also have a rectangular cross-section which is at least as long as the width of the stack 7 or the expanded metal meshes 10, 10′, 10″, . . . preferably protrudes beyond them.

Thus, the stack 7 can in sections only be welded together along its longitudinal direction through the electrode 4.

The stack 7 and the electrodes 4 are only displaced against each other in order to connect the complete length of the stack 7 as the complete width of the stack 7 is covered by its stamp surface (or electrode surface).

This temporal course is indicated through the dashed course 4′ (1^{st} weld) to 4″ (2^{nd} weld).

Thus, improvements concerning the flatness of individual expanded metal meshes 10, 10′, 10″, . . . and of the complete stack 7 can be achieved.

Moreover, through the presence of several capacities, the welding pulse can be controlled such that a splash formation is nearly avoided.

The arrangement of the control technology of the portal machine generates two counter-rotating magnetic fields, whereby no force on ferromagnetic particles is created and thus splash formation can be massively reduced.

Such a plant for the capacitor discharge welding method has several capacitors which are used for discharge for welding.

The capacitors can be charged to different degrees. This is enabled through the control of the portal machine. However, the portal machine can also have several capacitors which possess different charging capacities.

Also, the portal machine has a control which can charge and discharge the capacitors in different manners.

The following processing windows were identified as advantageous:
multiple pulses with up to five pulses;
waiting time between the pulses with up to 50 ms.

Here, at least one pre-pulse V and at least one main pulse H and optionally downstream post-pulses N have to be differentiated.

The pre-pulse V serves to activate the surfaces of the expanded metal meshes 10, 10′, 10″, . . . to be connected and thus to reduce splashes.

The at least one optional post-pulse N improves the joint zone regarding interfacing, thus it is possible to realize good interfaces at reduced peak currents and thus very little splash formation.

### Pre-Pulse

The object of the pre-pulse is to activate the surface in order to reduce welding splashes.

Through the choice of capacitors with a capacity of preferably 25% . . . 50% to the main pulse H or correspondingly different capacitor capacities, extremely short current increase times can be realized.

The energy per stamp surface is 0.3 . . . 1.75 J/mm²,
in particular 0.3 . . . 0.75 J/mm² for steel,
in particular for VA steel,
and 1.0 . . . 1.75 J/mm²,
in particular 1.0 . . . 1.3 J/mm²,
for titanium (Ti) or titanium alloys.

The ignition interval, i.e. the pulse pause, between the pre-pulse V and the main pulse H are chosen such that they are electrically and thermally coupled.

The ignition intervals are preferably between 2 ms . . . 10 ms.

### Main Pulse

The main pulse H is the first joint pulse.

The main pulse energy has an energy per surface of 0.75 . . . 3.25 J/mm²,
in particular 0.75 . . . 1.3 J/mm² for steel,
in particular VA steel,
and 2.0 . . . 3.25 J/mm²,
in particular 2.5 . . . 3.25 J/mm²,
for titanium (Ti) or for titanium alloys.

The ignition interval between the main pulse H and the optional post-pulse N is chosen such that they are electrically and thermally coupled.

The ignition intervals are preferably between 10 ms . . . 30 ms.

### Post-Pulse

By changing the resistances over the joint surface of the expanded metal meshes 10, 10′, 10″, . . . in connection with the sinking after the main pulse H, the post-pulse N is adjusted and serves as the second joint pulse.

The necessity of applying the post-pulse N is to be chosen depending on the materials of the expanded metal meshes 10, 10′, 10″.

Through the choice of capacitors with a capacity of 120% . . . 190% to the main pulse H, the required welding energy is provided.

The post-pulse energy per stamp surface is 1.1 . . . 4.0 J/mm²,
in particular 1.1 . . . 2.0 J/mm²,
particularly 1.1 . . . 1.3 J/mm²,
for steel, in particular VA steel,
and 2.2 . . . 4.0 J/mm²,
in particular 2.6 . . . 4.0 J/mm², for titanium (Ti) or titanium alloys.

FIG. 3 shows an example course of 3 pulses V, H, N.

The energy content E or the used capacity of the capacitor/capacitors is plotted on the y-axis versus the temporal course t of the discharge on the x-axis.

The area under the curve is a measure of the introduction of energy during welding.

Here, for example, this is a pre-pulse V, a main pulse H and a post-pulse N.

Due to the lower height of the maximum of the pre-pulse V with regard to the main pulse H or the post-pulse N, it can be clearly recognized that the used energy during the pre-pulse V or the used capacity of the capacitor is much lower.

The curves of the pulse courses are similar to a Weibull function with a steep course of the increase to the maximum.

The intervals of the maximums of the different and successive pulses V, H, N are also a measure of the distances of the ignition of the different capacitors for the different pulses.

Relatively shortly after the pre-pulse V, the main pulse H is ignited, which has a significantly larger energy with regard to the pre-pulse V and leads to the first welding of the metallic expanded metal meshes 10, 10′, 10″, . . . to be joined.

It is not necessary to use the one or more post-pulses N.

A larger interval between the post-pulse N and the main pulse H is not necessary, but performed here and recognizable, wherein a measurably higher energy is used for the post-pulse N compared to the main pulse H.

The following constellations for the pulses V-H-N are conceivable:
1-1-0
1-1-1
1-1-2
1-2-1
1-2-2.

The following welding parameters are advantageous:
force 20 kN . . . 130 kN,
total energy 28 kJ . . . 128 kJ for steel (VA) and up to 350 kJ for titanium or titanium alloys,
peak current 300 kA . . . 550 kA.

The following welding parameters with regard to the electrode surface are advantageous:

$$force 0. 5 \frac{N}{{mm}^{2}} … 3.5 \frac{N}{{mm}^{2}} ,$$

in particular

$$0. 5 \frac{N}{{mm}^{2}} … 0.8 \frac{N}{{mm}^{2}} ,$$

and/or
total energy

$$0.7 \frac{J}{{mm}^{2}} … 8.75 \frac{J}{{mm}^{2}} ,$$

in particular

$$3.4 \frac{J}{{mm}^{2}} … 8.75 \frac{J}{{mm}^{2}} ,$$

and/or
peak current

$$7.5 \frac{A}{{mm}^{2}} … 13.75 \frac{A}{{mm}^{2}} .$$

Or, in absolute values:
pressing force of the stamps (4) 20 kN . . . 130 kN and/or
total energy 28 kJ . . . 350 kJ depending on material and/or
peak current 300 kA . . . 550 kA depending on material.

The electrodes 4 preferably have the following sizes of 50×500 . . . 250×500 mm, preferably 50×400 . . . 100×400 mm.

FIG. 2 cross-section through an arrangement 1 according to FIG. 1.

The individual expanded metal meshes 10′, 10″, 10′″ can be recognized. During welding, a mechanical preload F is used.

For generating a stack 1, several expanded metal meshes 10, 10′, 10″, . . . can be welded simultaneously with one another or added individually, in pairs or several times in order to generate thicker stacks.

The main advantages are:
quicker and more cost-efficient production possible through inline-processes.
avoidance of welding splashes through multiple pulse technology.
improvement of flatness through larger welding electrodes.

FIG. 4 shows an example top view of an expanded metal mesh 10.

The expanded metal mesh 10 has a longitudinal direction 16.

The expanded metal mesh 10 has several through openings 13 which are preferably evenly distributed over the surface of the expanded metal mesh 10.

The openings 13 are preferably not round and have an aspect ratio of significantly larger than 1, i.e. at least 1.1, i.e. they are elongated and preferably extend in the direction of the longitudinal direction 16 of the expanded metal mesh 10.

The openings 13 can be formed to be oval or elliptical.

Further cross-sections are conceivable.

The expanded metal meshes 10′ 10′ ‘(FIG. 2) are preferably arranged one above the other such that the longitudinal directions 19 of the respective openings 13 of the respective layers 10’, 10″, . . . of the expanded metal meshes each run in the same direction.

1-20. (canceled)

21. A method for metallurgically bonding at least two metallic layers over a large surface, the method comprising:
providing a plurality of expanded metal meshes;
successively discharging a plurality of capacitors in a capacitor discharge welding method;
applying at least two pulses including at least one pre-pulse, at least one main pulse and optionally at least one post-pulse;
the at least two pulses differing at least in energy density in J/mm² by between at least 10% and at least 20%.

22. The method according to claim 21, which further comprises successively discharging the capacitors in the milliseconds range from 1 ms to 800 ms.

23. The method according to claim 21, which further comprises applying at least three to five pulses in total, and providing time intervals between the pulses differing by between at least 10% and at least 20%.

24. The method according to claim 21, which further comprises providing a waiting time between the pulses of between 1 ms and 50 ms.

25. The method according to claim 21, which further comprises:
performing no welding during the at least one pre-pulse;
providing the at least one pre-pulse with an energy per stamp surface of 0.3-1.75 J/mm²;
using 0.3-0.75 J/mm² for steel or for VA steel; and
using 1.0-1.75 J/mm² for titanium or titanium alloys.

26. The method according to claim 21, which further comprises:
performing a first welding during the at least one main pulse;
providing the at least one main pulse with an energy per stamp surface of 0.75-3.25 J/mm²;
using 0.75-1.3 J/mm² for steel or for VA steel; and
using 2.0-3.25 J/mm² for titanium or titanium alloys.

27. The method according to claim 21, which further comprises applying the at least one pre-pulse with a choice and discharge of capacitors having a capacity of 25%-50% of the main pulse to realize an extremely short current increase time.

28. The method according to claim 21, which further comprises:
adapting the post-pulse due to a change of resistances over a joint surface in connection with sinking after the main pulse and serving as a second joint pulse;
providing the at least one post-pulse with an energy per stamp surface of 1.1-4.0 J/mm²;
using 1.1-2.0 J/mm² for steel or for VA steel; and
using 2.2-4.0 J/mm² for titanium or titanium alloys.

29. The method according to claim 21, which further comprises providing a required welding energy for the at least one post-pulse through a choice of capacitors with a capacity of 120%-190% of the main pulse.

30. The method according to claim 21, which further comprises choosing an ignition interval between the pre-pulse and the main pulse to cause the pre-pulse and the main pulse to be electrically and thermally coupled.

31. The method according to claim 30, which further comprises selecting the ignition interval between the pre-pulse and the main pulse to be 2 ms to 10 ms.

32. The method according to claim 21, which further comprises selecting an ignition interval between the main pulse and the post-pulse to be 10 ms to 30 ms.

33. The method according to claim 21, which further comprises using at least one of the following welding parameters:
pressing force of stamps: 20 kN-130 kN, or
total energy 28 kJ-350 kJ depending on material, or
peak current 300 kA-550 kA depending on material.

34. The method according to claim 21, which further comprises using welding electrodes having a cross-section of 50-250 mm×400-500 mm.

35. The method according to claim 21, which further comprises using at least one of the following welding parameters with regard to an electrode surface:
$$force of electrodes : 0.5 \frac{N}{{mm}^{2}} - 3.5 \frac{N}{{mm}^{2}} ;$$
$$or$$
$$total energy : 0.7 \frac{J}{{mm}^{2}} - 8.75 \frac{J}{{mm}^{2}} ;$$
$$or$$
$$peak current : 7.5 \frac{A}{{mm}^{2}} - 13.75 \frac{A}{{mm}^{2}} .$$

36. The method according to claim 21, which further comprises using electrodes being at least as long as a width of the metallic layers or the expanded metal meshes to be welded.

37. A stack of expanded metal meshes produced and welded together according to claim 21, the stack comprising:
through openings formed in every expanded metal mesh;
every through opening having an aspect ratio larger than 1.1 in a longitudinal direction; and
the longitudinal directions of the openings of every expanded metal mesh being aligned with longitudinal directions of the expanded metal meshes.

38. A portal machine for performing a capacitor discharge welding method according to claim 21, the portal machine comprising a plurality of capacitors configured to be used for discharge for welding.

39. The portal machine according to claim 38, wherein the plurality of capacitors have different charging capacities.

40. The portal machine according to claim 38, which further comprises a control for charging the capacitors in different manners.
